(19) United States
(12) Patent Application Publication
(10) Pub. No.: US 2024/0131766 A1
(43) Pub. Date: Apr. 25, 2024

(54) DISPLAY UNIT, CONTROL DEVICE, AND INJECTION MOLDING MACHINE

(71) Applicant: SUMITOMO HEAVY INDUSTRIES, LTD., Tokyo (JP)

(72) Inventors: Takahiro NAMIKI, Chiba-shi (JP); Daigo HOTTA, Chiba-shi (JP); Takuya MATSUNAGA, Chiba-shi (JP); Tomohiro HIRANO, Chiba-shi (JP)

(21) Appl. No.: 18/460,571

(22) Filed: Sep. 2, 2023

(30) Foreign Application Priority Data
Oct. 19, 2022 (JP) 2022-168530

(51) Int. Cl. B29C 45/76

(52) U.S. Cl. CPC B29C 45/7666; B29C 45/7626; B29C 2045/7606

(57) ABSTRACT

A display unit displays a display screen including information on injection molding, and the display screen displays an actual result information display field that displays actual result information on power consumption measured at a time of performing the injection molding and a comparative information display field that displays comparative information on power consumption of the injection molding to be compared with the actual result information on the power consumption in the same display form as a display form of the actual result information display field together.

### CROSS-REFERENCE TO RELATED APPLICATIONS

This application claims priority to Japanese Patent Application No. 2022-168530, filed on Oct. 20, 2022, which is incorporated by reference herein in its entirety.

### BACKGROUND

### Technical Field

Certain embodiments of the present disclosure relate to a display unit, a control device, and an injection molding machine.

### Description of Related Art

The related art discloses a control device of an injection molding machine that measures the power consumption of injection molding to calculate the amount of power and that displays the amount of power on a display unit (display). This control device includes a dedicated display screen for displaying power consumption, and can display conversion information and the amount of power together. The conversion information includes, for example, information related to future prediction obtained on the basis of a conversion database for power consumption with respect to the amount of change of molding conditions.

A display unit in the related art displays current data and predictive data, and switches and displays the display of the current data and the display of the predictive data on separate screens (for example, see [0043] of the related art). For this reason, the current data and the predictive data are not displayed on the same screen.

### SUMMARY

According to an aspect of the present invention, there is provided a display unit that displays a display screen including information on injection molding. The display screen displays an actual result information display field that displays actual result information on power consumption measured at a time of performing the injection molding, and a comparative information display field that displays comparative information on power consumption of the injection molding to be compared with the actual result information on the power consumption in a same display form as a display form of the actual result information display field together.

### BRIEF DESCRIPTION OF THE DRAWINGS

FIG. 1 is a diagram showing a state of an injection molding machine according to an embodiment at the time of completion of mold opening.

FIG. 2 is a diagram showing a state of the injection molding machine according to the embodiment at the time of mold clamping.

FIG. 3 is a diagram showing an example of components of a control device as functional blocks.

FIG. 4 is a diagram showing an example of processes of a molding cycle.

FIG. 5 is a diagram showing an example of a display screen of a display unit according to one embodiment.

FIG. 6 is a diagram partially showing a display screen according to another embodiment.

FIG. 7 is a diagram showing an example of a process-screen portion according to a modification example.

### DETAILED DESCRIPTION

Meanwhile, in a case where a user adjusts the power consumption of injection molding, it is preferable that an actual result of the power consumption of injection molding during an operation and comparative information having has the same form as the actual result of the power consumption are provided on the same screen.

It is desirable to provide a technique that allows easy comparison of an actual result and comparative information of power consumption of injection molding.

According to the aspect, it is possible to easily compare power consumption of injection molding set arbitrarily by a user.

Embodiments of the present disclosure will be described below with reference to the drawings. The same components will be denoted in the respective drawings by the same reference numerals, and the repeated description thereof will be omitted.

### Injection Molding Machine

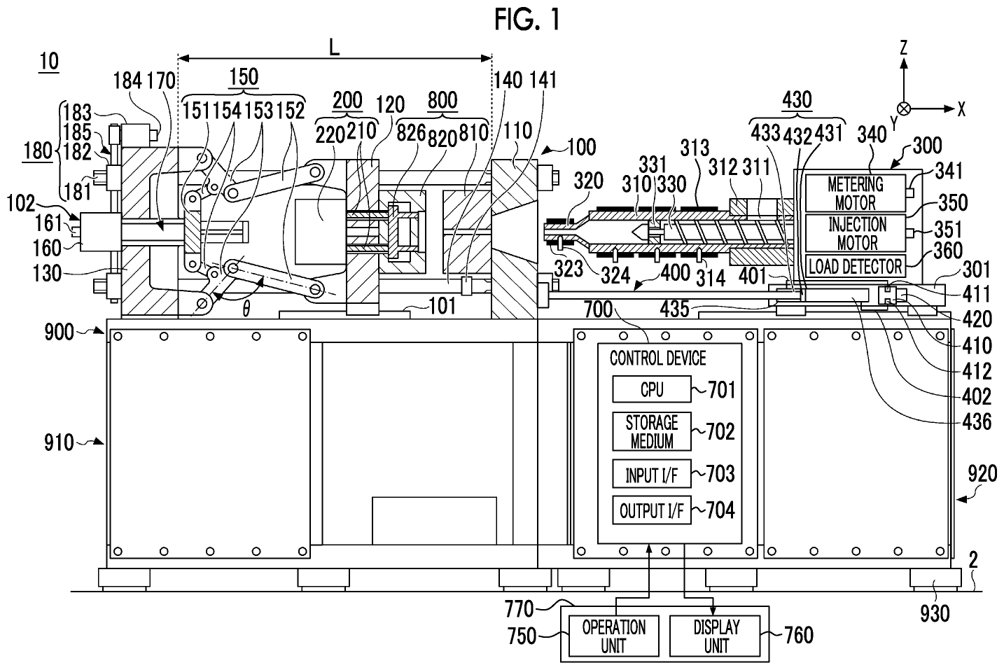

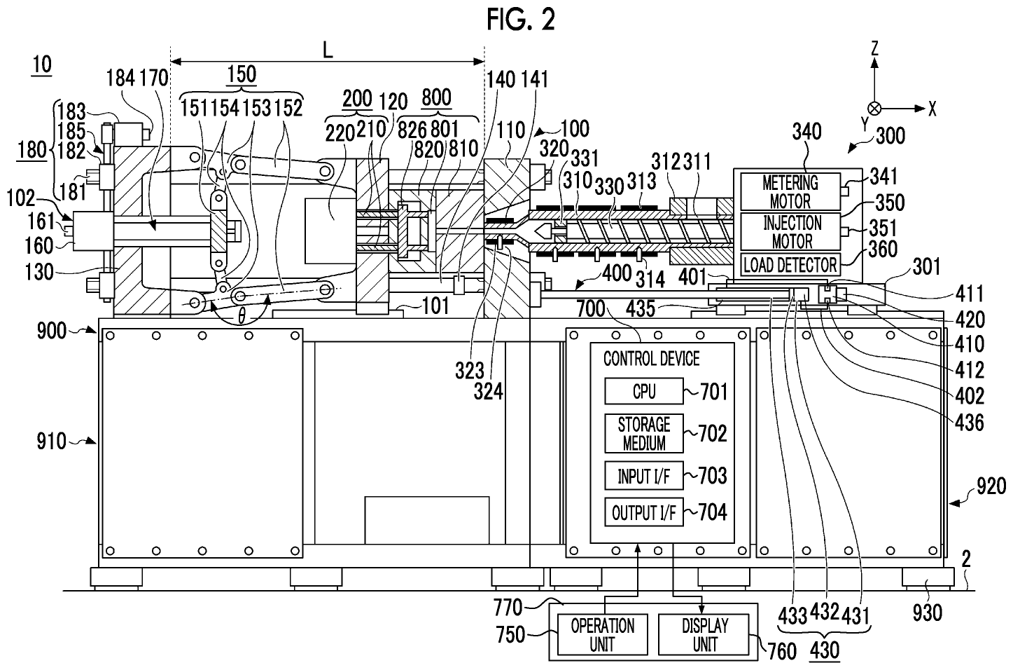

FIG. 1 is a diagram showing a state of an injection molding machine according to an embodiment at the time of completion of mold opening. FIG. 2 is a diagram showing a state of the injection molding machine according to the embodiment at the time of mold clamping. In this specification, an X-axis direction, a Y-axis direction, and a Z-axis direction are directions perpendicular to each other. The X-axis direction and the Y-axis direction indicate horizontal directions, and the Z-axis direction indicates a vertical direction. In a case where a mold clamping unit 100 is of a horizontal type, the X-axis direction is a mold opening/closing direction and the Y-axis direction is a width direction of an injection molding machine 10. A negative side in the Y-axis direction is referred to as an operation side, and a positive side in the Y-axis direction is referred to as a counter-operation side.

As shown in FIGS. 1 and 2, the injection molding machine 10 includes a mold clamping unit 100 that opens and closes a mold unit 800, an ejector unit 200 that ejects molding products molded by the mold unit 800, an injection unit 300 that injects a molding material into the mold unit 800, a moving unit 400 that causes the injection unit 300 to advance and retreat with respect to the mold unit 800, a control device 700 that controls the respective components of the injection molding machine 10, and a frame 900 that supports the respective components of the injection molding machine 10. The frame 900 includes a mold clamping unit frame 910 that supports the mold clamping unit 100, and an injection unit frame 920 that supports the injection unit 300. The mold clamping unit frame 910 and the injection unit frame 920 are installed on a floor 2 via leveling adjusters 930, respectively. The control device 700 is disposed in an internal space of the injection unit frame 920. The respective components of the injection molding machine 10 will be described below.

### Mold Clamping Unit

In the description of the mold clamping unit 100, a moving direction of a movable platen 120 in a case where a mold is to be closed (for example, an X-axis positive direction) will correspond to a front, and a moving direction of the movable platen 120 in a case where the mold is to be opened (for example, an X-axis negative direction) will correspond to a rear.

The mold clamping unit 100 performs mold closing, pressurization, mold clamping, depressurization, and mold opening of the mold unit 800. The mold unit 800 includes a stationary mold 810 and a movable mold 820.

The mold clamping unit 100 is of, for example, a horizontal type, and the mold opening/closing direction of the mold clamping unit 100 is a horizontal direction. The mold clamping unit 100 includes a stationary platen 110 to which the stationary mold 810 is attached, the movable platen 120 to which the movable mold 820 is attached, and a moving mechanism 102 that moves the movable platen 120 with respect to the stationary platen 110 in the mold opening/closing direction.

The stationary platen 110 is fixed to the mold clamping unit frame 910. The stationary mold 810 is attached to a surface of the stationary platen 110 facing the movable platen 120.

The movable platen 120 is disposed to be movable with respect to the mold clamping unit frame 910 in the mold opening/closing direction. Guides 101 that guide the movable platen 120 are laid on the mold clamping unit frame 910. The movable mold 820 is attached to a surface of the movable platen 120 facing the stationary platen 110.

The moving mechanism 102 causes the movable platen 120 to advance and retreat with respect to the stationary platen 110 to perform mold closing, pressurization, mold clamping, depressurization, and mold opening of the mold unit 800. The moving mechanism 102 includes a toggle support 130 that is disposed with an interval between the stationary platen 110 and itself, tie bars 140 that connect the stationary platen 110 to the toggle support 130, a toggle mechanism 150 that moves the movable platen 120 with respect to the toggle support 130 in the mold opening/closing direction, a mold clamping motor 160 that operates the toggle mechanism 150, a motion conversion mechanism 170 that converts a rotary motion of the mold clamping motor 160 into a linear motion, and a mold space adjustment mechanism 180 that adjusts an interval between the stationary platen 110 and the toggle support 130.

The toggle support 130 is disposed with an interval between the stationary platen 110 and itself, and is placed on the mold clamping unit frame 910 to be movable in the mold opening/closing direction. The toggle support 130 may be disposed to be movable along guides laid on the mold clamping unit frame 910. The guides for the toggle support 130 may be common to the guides 101 for the movable platen 120.

In the present embodiment, the stationary platen 110 is fixed to the mold clamping unit frame 910, and the toggle support 130 is disposed to be movable with respect to the mold clamping unit frame 910 in the mold opening/closing direction. However, the toggle support 130 may be fixed to the mold clamping unit frame 910, and the stationary platen 110 may be disposed to be movable with respect to the mold clamping unit frame 910 in the mold opening/closing direction.

The tie bars 140 connect the stationary platen 110 to the toggle support 130 with an interval L between the stationary platen 110 and the toggle support 130 in the mold opening/closing direction. A plurality of (for example, four) tie bars 140 may be used. The plurality of tie bars 140 are disposed parallel to the mold opening/closing direction and extend depending on a mold clamping force. At least one tie bar 140 may be provided with a tie bar strain detector 141 that measures a strain of the tie bar 140. The tie bar strain detector 141 sends a signal indicating the detection result thereof to the control device 700. The detection result of the tie bar strain detector 141 may be used for the measurement of a mold clamping force, and the like.

The tie bar strain detector 141 is used in the present embodiment as a mold clamping force detector for detecting a mold clamping force, but the present invention is not limited thereto. The mold clamping force detector is not limited to a strain gauge type and may be of a piezoelectric type, a capacitive type, a hydraulic type, an electromagnetic type, or the like. A position where the mold clamping force detector is attached is also not limited to the tie bar 140.

The toggle mechanism 150 is disposed between the movable platen 120 and the toggle support 130, and moves the movable platen 120 with respect to the toggle support 130 in the mold opening/closing direction. The toggle mechanism 150 includes a crosshead 151 that moves in the mold opening/closing direction and a pair of link groups that is bent and stretched depending on the movement of the crosshead 151. Each of the pair of link groups includes a first link 152 and a second link 153 that are bendably and stretchably connected to each other by a pin or the like. The first link 152 is oscillatingly attached to the movable platen 120 by a pin or the like. The second link 153 is oscillatingly attached to the toggle support 130 by a pin or the like. The second link 153 is attached to the crosshead 151 via a third link 154. In a case where the crosshead 151 is caused to advance and retreat with respect to the toggle support 130, the first and second links 152 and 153 are bent and stretched, and the movable platen 120 advances and retreats with respect to the toggle support 130.

The configuration of the toggle mechanism 150 is not limited to the configuration shown in FIGS. 1 and 2. For example, the number of nodes of each link group is five in FIGS. 1 and 2 but may be four. One end portion of the third link 154 may be connected to the node between the first and second links 152 and 153.

The mold clamping motor 160 is attached to the toggle support 130 and operates the toggle mechanism 150. The mold clamping motor 160 causes the crosshead 151 to advance and retreat with respect to the toggle support 130, so that the first and second links 152 and 153 are bent and stretched to cause the movable platen 120 to advance and retreat with respect to the toggle support 130. The mold clamping motor 160 is directly connected to the motion conversion mechanism 170, but may be connected to the motion conversion mechanism 170 via a belt, pulleys, and the like.

The motion conversion mechanism 170 converts a rotary motion of the mold clamping motor 160 into a linear motion of the crosshead 151. The motion conversion mechanism 170 includes a screw shaft and a screw nut that is screwed to the screw shaft. Balls or rollers may be interposed between the screw shaft and the screw nut.

The mold clamping unit 100 performs a mold closing process, a pressurization process, a mold clamping process, a depressurization process, a mold opening process, and the like under the control of the control device 700.

In the mold closing process, the mold clamping motor 160 is driven to cause the crosshead 151 to advance up to a mold closing completion position at a set movement speed, so that the movable platen 120 is caused to advance and causes the movable mold 820 to touch the stationary mold 810. The position and the movement speed of the crosshead 151 are measured using, for example, a mold clamping motor encoder 161 or the like. The mold clamping motor encoder 161 measures the rotation of the mold clamping motor 160, and sends a signal indicating the detection result thereof to the control device 700.

A crosshead position detector for measuring the position of the crosshead 151 and a crosshead movement speed detector for measuring the movement speed of the crosshead 151 are not limited to the mold clamping motor encoder 161, and general detectors can be used. Further, a movable platen position detector for measuring the position of the movable platen 120 and a movable platen movement speed detector for measuring the movement speed of the movable platen 120 are not limited to the mold clamping motor encoder 161, and general detectors can be used.

In the pressurization process, the mold clamping motor 160 is further driven to further cause the crosshead 151 to advance from the mold closing completion position up to a mold clamping position and to generate a mold clamping force.

In the mold clamping process, the mold clamping motor 160 is driven to maintain the position of the crosshead 151 at the mold clamping position. In the mold clamping process, the mold clamping force generated in the pressurization process is maintained. In the mold clamping process, cavity spaces 801 (see FIG. 2) are formed between the movable mold 820 and the stationary mold 810, and the injection unit 300 fills the cavity spaces 801 with liquid molding material. Molding products are obtained in a case where the molding material filling the cavity spaces is solidified.

One cavity space 801 may be provided, or a plurality of cavity spaces 801 may be provided. In the latter case, a plurality of molding products are obtained at the same time. An insert material may be disposed in a part of each cavity space 801, and the other part of each cavity space 801 may be filled with a molding material. Molding products in which the insert material and the molding material are integrated with each other are obtained.

In the depressurization process, the mold clamping motor 160 is driven to cause the crosshead 151 to retreat from the mold clamping position up to a mold opening start position, so that the movable platen 120 is caused to retreat to reduce the mold clamping force. The mold opening start position and the mold closing completion position may be the same position.

In the mold opening process, the mold clamping motor 160 is driven to cause the crosshead 151 to retreat from the mold opening start position up to a mold opening completion position at a set movement speed, so that the movable platen 120 is caused to retreat and causes the movable mold 820 to be separated from the stationary mold 810. After that, the ejector unit 200 ejects the molding products from the movable mold 820.

Set conditions in the mold closing process, the pressurization process, and the mold clamping process are collectively set as a series of set conditions. For example, movement speeds and positions (including a mold closing start position, a movement speed switching position, a mold closing completion position, and a mold clamping position) of the crosshead 151 and mold clamping forces in the mold closing process and the pressurization process are collectively set as a series of set conditions. The mold closing start position, the movement speed switching position, the mold closing completion position, and the mold clamping position are arranged in this order from a rear side toward the front, and indicate starting points and end points of sections in which the movement speeds are set. The movement speed is set for each section. One movement speed switching position may be set, or a plurality of movement speed switching positions may be set. The movement speed switching position may not be set. Only one of the mold clamping position and the mold clamping force may be set.

Set conditions in the depressurization process and the mold opening process are also collectively set in the same manner. For example, movement speeds and positions (including the mold opening start position, the movement speed switching position, and the mold opening completion position) of the crosshead 151 in the depressurization process and the mold opening process are collectively set as a series of set conditions. The mold opening start position, the movement speed switching position, and the mold opening completion position are arranged in this order from a front side toward the rear, and indicate starting points and end points of sections in which the movement speeds are set. The movement speed is set for each section. One movement speed switching position may be set, or a plurality of movement speed switching positions may be set. The movement speed switching position may not be set. The mold opening start position and the mold closing completion position may be the same position. Further, the mold opening completion position and the mold closing start position may be the same position.

The movement speeds, the positions, and the like of the movable platen 120 may be set instead of the movement speeds, the positions, and the like of the crosshead 151. Further, a mold clamping force may be set instead of the position (for example, the mold clamping position) of the crosshead or the position of the movable platen.

The toggle mechanism 150 amplifies the driving force of the mold clamping motor 160 and transmits the amplified driving force to the movable platen 120. The amplification factor of the toggle mechanism 150 is also referred to as a toggle factor. The toggle factor is changed depending on an angle θ between the first and second links 152 and 153 (hereinafter, also referred to as a “link angle θ”). The link angle θ is obtained from the position of the crosshead 151. In a case where the link angle θ is 180°, the toggle factor is at its maximum.

In a case where the thickness of the mold unit 800 is changed due to the replacement of the mold unit 800, a change in the temperature of the mold unit 800, or the like, a mold space is adjusted such that a predetermined mold clamping force is obtained during mold clamping. In the adjustment of a mold space, the interval L between the stationary platen 110 and the toggle support 130 is adjusted such that the link angle θ of the toggle mechanism 150 is a predetermined angle at a point of mold touch time when, for example, the movable mold 820 touches the stationary mold 810.

The mold clamping unit 100 includes a mold space adjustment mechanism 180. The mold space adjustment mechanism 180 adjusts the interval L between the stationary platen 110 and the toggle support 130 to adjust a mold space. A timing when a mold space is adjusted is, for example, between the end of a molding cycle and the start of the next molding cycle. The mold space adjustment mechanism 180 includes, for example, screw shafts 181 that are formed at rear end portions of the tie bars 140, screw nuts 182 that are rotatably held by the toggle support 130 not to be capable of advancing and retreating, and a mold space adjustment motor 183 that rotates the screw nuts 182 screwed to the screw shafts 181.

The screw shaft 181 and the screw nut 182 are provided for each tie bar 140. A rotational driving force of the mold space adjustment motor 183 may be transmitted to a plurality of screw nuts 182 via a rotational driving force transmission unit 185. The plurality of screw nuts 182 can be rotated in synchronization. It is also possible to individually rotate the plurality of screw nuts 182 by changing the transmission channel of the rotational driving force transmission unit 185.

The rotational driving force transmission unit 185 includes, for example, gears and the like. In this case, a driven gear is formed on an outer periphery of each screw nut 182, a driving gear is attached to an output shaft of the mold space adjustment motor 183, and an intermediate gear, which meshes with the plurality of driven gears and the driving gear, is rotatably held at a central portion of the toggle support 130. The rotational driving force transmission unit 185 may include a belt, pulleys, and the like instead of the gears.

The operation of the mold space adjustment mechanism 180 is controlled by the control device 700. The control device 700 drives the mold space adjustment motor 183 to rotate the screw nuts 182. As a result, the position of the toggle support 130 with respect to the tie bars 140 is adjusted, so that the interval L between the stationary platen 110 and the toggle support 130 is adjusted. A plurality of mold space adjustment mechanisms may be used in combination.

The interval L is measured using a mold space adjustment motor encoder 184. The mold space adjustment motor encoder 184 measures an amount of rotation and a rotation direction of the mold space adjustment motor 183, and sends signals indicating the detection results thereof to the control device 700. The detection results of the mold space adjustment motor encoder 184 are used for the monitoring and control of the position of the toggle support 130 and the interval L. A toggle support position detector for measuring the position of the toggle support 130 and an interval detector for measuring the interval L are not limited to the mold space adjustment motor encoder 184, and general detectors can be used.

The mold clamping unit 100 may include a mold temperature control machine that adjusts the temperature of the mold unit 800. The mold unit 800 includes a flow channel for a temperature control medium therein. The mold temperature control machine adjusts the temperature of a temperature control medium, which is supplied to the flow channel of the mold unit 800, to adjust the temperature of the mold unit 800.

The mold clamping unit 100 of the present embodiment is of a horizontal type in which a mold opening/closing direction is a horizontal direction, but may be of a vertical type in which a mold opening/closing direction is a vertical direction.

The mold clamping unit 100 of the present embodiment includes the mold clamping motor 160 as a drive unit, but may include a hydraulic cylinder instead of the mold clamping motor 160. Further, the mold clamping unit 100 may include a linear motor for opening and closing the mold and may include an electromagnet for clamping the mold.

### Ejector Unit

In the description of the ejector unit 200, as in the description of the mold clamping unit 100, the moving direction of the movable platen 120 in a case where the mold is to be closed (for example, the X-axis positive direction) will correspond to a front, and the moving direction of the movable platen 120 in a case where the mold is to be opened (for example, the X-axis negative direction) will correspond to a rear.

The ejector unit 200 is attached to the movable platen 120, and advances and retreats together with the movable platen 120. The ejector unit 200 includes ejector rods 210 that eject the molding products from the mold unit 800, and a drive mechanism 220 that moves the ejector rods 210 in the moving direction of the movable platen 120 (X-axis direction).

The ejector rods 210 are disposed in through-holes of the movable platen 120 to be capable of advancing and retreating. Front end portions of the ejector rods 210 are in contact with an ejector plate 826 of the movable mold 820. The front end portions of the ejector rods 210 may be connected to or may not be connected to the ejector plate 826.

The drive mechanism 220 includes, for example, an ejector motor and a motion conversion mechanism that converts a rotary motion of the ejector motor into a linear motion of the ejector rods 210. The motion conversion mechanism includes a screw shaft and a screw nut that is screwed to the screw shaft. Balls or rollers may be interposed between the screw shaft and the screw nut.

The ejector unit 200 performs an ejection process under the control of the control device 700. In the ejection process, the ejector rods 210 are caused to advance up to an ejection position from a standby position at a set movement speed, so that the ejector plate 826 is caused to advance to eject the molding products. After that, the ejector motor is driven to cause the ejector rods 210 to retreat at a set movement speed and to cause the ejector plate 826 to retreat up to the original standby position.

The position and the movement speed of each ejector rod 210 are measured using, for example, an ejector motor encoder. The ejector motor encoder measures the rotation of the ejector motor, and sends a signal indicating the detection result thereof to the control device 700. An ejector rod position detector for measuring the position of each ejector rod 210 and an ejector rod movement speed detector for measuring the movement speed of each ejector rod 210 are not limited to the ejector motor encoder, and general detectors can be used.

### Injection Unit

In the description of the injection unit 300, unlike in the description of the mold clamping unit 100 and the description of the ejector unit 200, a moving direction of a screw 330 during filling (for example, the X-axis negative direction) will correspond to a front, and a moving direction of the screw 330 during metering (for example, the X-axis positive direction) will correspond to a rear.

The injection unit 300 is installed on a slide base 301, and the slide base 301 is disposed to be capable of advancing and retreating with respect to the injection unit frame 920. The injection unit 300 is disposed to be capable of advancing and retreating with respect to the mold unit 800. The injection unit 300 touches the mold unit 800, and fills the cavity spaces 801 formed in the mold unit 800 with a molding material. The injection unit 300 includes, for example, a cylinder 310 that heats the molding material, a nozzle 320 that is provided at a front end portion of the cylinder 310, the screw 330 that is disposed in the cylinder 310 to be capable of advancing and retreating and to be rotatable, a metering motor 340 that rotates the screw 330, an injection motor 350 that causes the screw 330 to advance and retreat, and a load detector 360 that measures a load transmitted between the injection motor 350 and the screw 330.

The cylinder 310 heats the molding material fed from a feed port 311 to the inside. The molding material includes, for example, a resin and the like. The molding material is formed in the shape of, for example, pellets and is fed to the feed port 311 in a solid state. The feed port 311 is formed at a rear portion of the cylinder 310. A cooler 312, such as a water cooling cylinder, is provided on an outer periphery of the rear portion of the cylinder 310. First heating units 313, such as band heaters, and first temperature measurers 314 are provided on the outer periphery of the cylinder 310 in front of the cooler 312.

The cylinder 310 is divided into a plurality of zones in an axial direction of the cylinder 310 (for example, the X-axis direction). The first heating unit 313 and the first temperature measurer 314 are provided in each of the plurality of zones. A set temperature is set in each of the plurality of zones, and the control device 700 controls the first heating units 313 such that temperatures measured by the first temperature measurers 314 reach the set temperatures.

The nozzle 320 is provided at the front end portion of the cylinder 310, and is pressed against the mold unit 800. Second heating units 323 and second temperature measurers 324 are provided on an outer periphery of the nozzle 320. The control device 700 controls the second heating units 323 such that the measured temperature of the nozzle 320 reaches a set temperature.

The screw 330 is disposed in the cylinder 310 to be capable of advancing and retreating and to be rotatable. In a case where the screw 330 is rotated, a molding material is fed forward along a helical groove of the screw 330. The molding material is gradually melted by heat from the cylinder 310 while being fed forward. As the liquid molding material is fed in front of the screw 330 and is accumulated in the front portion of the cylinder 310, the screw 330 is caused to retreat. After that, in a case where the screw 330 is caused to advance, the liquid molding material accumulated in front of the screw 330 is injected from the nozzle 320 and the mold unit 800 is filled with the molding material.

A backflow prevention ring 331 is attached to a front portion of the screw 330 to be capable of advancing and retreating as a backflow prevention valve that prevents the backflow of the molding material flowing rearward from the front of the screw 330 in a case where the screw 330 is pushed forward.

In a case where the screw 330 is caused to advance, the backflow prevention ring 331 is pushed rearward by the pressure of the molding material accumulated in front of the screw 330 and retreats relative to the screw 330 up to a close position (see FIG. 2) where the flow channel for a molding material is closed. Accordingly, the molding material accumulated in front of the screw 330 is prevented from flowing back to the rear.

On the other hand, in a case where the screw 330 is rotated, the backflow prevention ring 331 is pushed forward by the pressure of the molding material fed forward along the helical groove of the screw 330 and advances relative to the screw 330 up to an open position (see FIG. 1) where the flow channel for a molding material is opened. Accordingly, the molding material is fed in front of the screw 330.

The backflow prevention ring 331 may be of either a co-rotation type that is rotated together with the screw 330 or a non-co-rotation type that is not rotated together with the screw 330.

The injection unit 300 may include a drive source that causes the backflow prevention ring 331 to advance and retreat with respect to the screw 330 between the open position and the close position.

The metering motor 340 rotates the screw 330. A drive source that rotates the screw 330 is not limited to the metering motor 340, and may be, for example, a hydraulic pump or the like.

The injection motor 350 causes the screw 330 to advance and retreat. A motion conversion mechanism that converts a rotary motion of the injection motor 350 into a linear motion of the screw 330, and the like are provided between the injection motor 350 and the screw 330. The motion conversion mechanism includes, for example, a screw shaft and a screw nut that is screwed to the screw shaft. Balls, rollers, or the like may be provided between the screw shaft and the screw nut. A drive source that causes the screw 330 to advance and retreat is not limited to the injection motor 350, and may be, for example, a hydraulic cylinder or the like.

The load detector 360 measures a load that is transmitted between the injection motor 350 and the screw 330. The measured load is converted into a pressure by the control device 700. The load detector 360 is provided in a transmission channel for a load between the injection motor 350 and the screw 330, and measures a load that acts on the load detector 360.

The load detector 360 sends a signal of the measured load to the control device 700. The load measured by the load detector 360 is converted into a pressure that acts between the screw 330 and the molding material, and is used for the control and monitoring of a pressure that is received by the screw 330 from the molding material, a back pressure that acts on the screw 330, a pressure that acts on the molding material from the screw 330, and the like.

A pressure detector that measures the pressure of the molding material is not limited to the load detector 360, and a general detector can be used. For example, a nozzle pressure sensor or a mold internal pressure sensor may be used. The nozzle pressure sensor is installed in the nozzle 320. The mold internal pressure sensor is installed in the mold unit 800.

The injection unit 300 performs a metering process, a filling process, a holding pressure process, and the like under the control of the control device 700. The filling process and the holding pressure process may also be collectively referred to as an injection process.

In the metering process, the metering motor 340 is driven to rotate the screw 330 at a set rotating speed to feed the molding material forward along the helical groove of the screw 330. Accordingly, the molding material is gradually melted. As the liquid molding material is fed in front of the screw 330 and is accumulated in the front portion of the cylinder 310, the screw 330 is caused to retreat. A rotating speed of the screw 330 is measured using, for example, a metering motor encoder 341. The metering motor encoder 341 measures the rotation of the metering motor 340 and sends a signal indicating the detection result thereof to the control device 700. A screw rotating speed detector that measures the rotating speed of the screw 330 is not limited to the metering motor encoder 341, and a general detector can be used.

In the metering process, the injection motor 350 may be driven to apply a set back pressure to the screw 330 to limit the sudden retreat of the screw 330. The back pressure applied to the screw 330 is measured using, for example, the load detector 360. In a case where the screw 330 retreats up to a metering completion position and a predetermined amount of molding material is accumulated in front of the screw 330, the metering process is completed.

Positions and rotating speeds of the screw 330 in the metering process are collectively set as a series of set conditions. For example, a metering start position, a rotating speed switching position, and a metering completion position are set. These positions are arranged in this order from the front side toward the rear, and indicate starting points and end points of sections in which the rotating speeds are set. The rotating speed is set for each section. One rotating speed switching position may be set, or a plurality of rotating speed switching positions may be set. The rotating speed switching position may not be set. Further, a back pressure is set for each section.

In the filling process, the injection motor 350 is driven to cause the screw 330 to advance at a set movement speed and to fill the cavity spaces 801 formed in the mold unit 800 with the liquid molding material accumulated in front of the screw 330. The position and movement speed of the screw 330 are measured using, for example, an injection motor encoder 351. The injection motor encoder 351 measures the rotation of the injection motor 350 and sends a signal indicating the detection result thereof to the control device 700. In a case where the position of the screw 330 reaches a set position, the switching of the filling process to the holding pressure process (so-called V/P switching) is performed. A position where V/P switching is performed is also referred to as a V/P switching position. The set movement speed of the screw 330 may be changed depending on the position of the screw 330, a time, or the like.

Positions and movement speeds of the screw 330 in the filling process are collectively set as a series of set conditions. For example, a filling start position (also referred to as an “injection start position”), a movement speed switching position, and a V/P switching position are set. These positions are arranged in this order from the rear side toward the front, and indicate starting points and end points of sections in which the movement speeds are set. The movement speed is set for each section. One movement speed switching position may be set, or a plurality of movement speed switching positions may be set. The movement speed switching position may not be set.

An upper limit of the pressure of the screw 330 is set for each section in which the movement speed of the screw 330 is set. The pressure of the screw 330 is measured by the load detector 360. In a case where the pressure of the screw 330 is equal to or lower than a setting pressure, the screw 330 advances at a set movement speed. On the other hand, in a case where the pressure of the screw 330 exceeds the setting pressure, the screw 330 advances at a movement speed lower than the set movement speed so that the pressure of the screw 330 is equal to or lower than the setting pressure for the purpose of protecting the mold.

After the position of the screw 330 reaches the V/P switching position in the filling process, the screw 330 may be caused to temporarily stop at the V/P switching position, and the V/P switching may be then performed. Immediately before the V/P switching, instead of the screw 330 being stopped, the screw 330 may advance at a very low speed or retreat at a very low speed. Further, a screw position detector for measuring the position of the screw 330 and a screw movement speed detector for measuring the movement speed of the screw 330 are not limited to the injection motor encoder 351, and general detectors can be used.

In the holding pressure process, the injection motor 350 is driven to push the screw 330 forward to maintain the pressure of the molding material at a front end portion of the screw 330 (hereinafter, also referred to as a “holding pressure”) at a setting pressure and to push a molding material remaining in the cylinder 310 toward the mold unit 800. An insufficient amount of the molding material due to cooling shrinkage inside the mold unit 800 can be replenished. The holding pressure is measured using, for example, the load detector 360. A set value of the holding pressure may be changed depending on a time that has passed from the start of the holding pressure process, or the like. A plurality of holding pressures and a plurality of holding times in which the holding pressure is held in the holding pressure process may be set, and may be collectively set as a series of set conditions.

The molding material, with which the cavity spaces 801 formed in the mold unit 800 is filled, is gradually cooled in the holding pressure process, and an inlet of the cavity spaces 801 is closed by the solidified molding material at the time of completion of the holding pressure process. This state is referred to as a gate seal, and the backflow of the molding material from the cavity spaces 801 is prevented. A cooling process is started after the holding pressure process. The molding material in the cavity spaces 801 is solidified in the cooling process. The metering process may be performed in the cooling process for the purpose of shortening a molding cycle time.

The injection unit 300 of the present embodiment is of an in-line screw type, but may be of a pre-plasticizing type or the like. A pre-plasticizing type injection unit feeds a molding material, which is melted in a plasticizing cylinder, to an injection cylinder and injects the molding material into a mold unit from the injection cylinder. A screw is disposed in the plasticizing cylinder to be rotatable and not to be capable of advancing and retreating, or a screw is disposed in the plasticizing cylinder to be rotatable and to be capable of advancing and retreating. Meanwhile, a plunger is disposed in the injection cylinder to be capable of advancing and retreating.

Further, the injection unit 300 of the present embodiment is of a horizontal type in which the axial direction of the cylinder 310 is a horizontal direction, but may be of a vertical type in which the axial direction of the cylinder 310 is a vertical direction. A mold clamping unit to be combined with a vertical type injection unit 300 may be of a vertical type or a horizontal type. Likewise, a mold clamping unit to be combined with a horizontal type injection unit 300 may be of a horizontal type or a vertical type.

### Moving Unit

In the description of the moving unit 400, as in the description of the injection unit 300, the moving direction of the screw 330 during filling (for example, the X-axis negative direction) will correspond to a front, and the moving direction of the screw 330 during metering (for example, the X-axis positive direction) will correspond to a rear.

The moving unit 400 causes the injection unit 300 to advance and retreat with respect to the mold unit 800. Further, the moving unit 400 presses the nozzle 320 against the mold unit 800 to generate a nozzle touch pressure. The moving unit 400 includes a hydraulic pump 410, a motor 420 as a drive source, a hydraulic cylinder 430 as a hydraulic actuator, and the like.

The hydraulic pump 410 includes a first port 411 and a second port 412. The hydraulic pump 410 is a pump that can be rotated in both directions, and sucks hydraulic fluid (for example, oil) from any one of the first port 411 and the second port 412 and discharges the hydraulic fluid from the other thereof to generate hydraulic pressure in a case where a rotation direction of the motor 420 is changed. The hydraulic pump 410 can also suck hydraulic fluid from a tank and discharge the hydraulic fluid from any one of the first port 411 and the second port 412.

The motor 420 causes the hydraulic pump 410 to operate. The motor 420 drives the hydraulic pump 410 in a rotation direction, which corresponds to a control signal sent from the control device 700, with rotation torque corresponding to the control signal. The motor 420 may be an electric motor or may be an electric servomotor.

The hydraulic cylinder 430 includes a cylinder body 431, a piston 432, and a piston rod 433. The cylinder body 431 is fixed to the injection unit 300. The piston 432 partitions the inside of the cylinder body 431 into a front chamber 435 as a first chamber and a rear chamber 436 as a second chamber. The piston rod 433 is fixed to the stationary platen 110.

The front chamber 435 of the hydraulic cylinder 430 is connected to the first port 411 of the hydraulic pump 410 via a first flow channel 401. In a case where hydraulic fluid discharged from the first port 411 is supplied to the front chamber 435 via the first flow channel 401, the injection unit 300 is pushed forward. The injection unit 300 advances, so that the nozzle 320 is pressed against the stationary mold 810. The front chamber 435 functions as a pressure chamber that generates the nozzle touch pressure of the nozzle 320 with the pressure of the hydraulic fluid supplied from the hydraulic pump 410.

On the other hand, the rear chamber 436 of the hydraulic cylinder 430 is connected to the second port 412 of the hydraulic pump 410 via a second flow channel 402. In a case where hydraulic fluid discharged from the second port 412 is supplied to the rear chamber 436 of the hydraulic cylinder 430 via the second flow channel 402, the injection unit 300 is pushed rearward. The injection unit 300 retreats, so that the nozzle 320 is separated from the stationary mold 810.

The moving unit 400 includes the hydraulic cylinder 430 in the present embodiment, but the present invention is not limited thereto. For example, an electric motor and a motion conversion mechanism that converts a rotary motion of the electric motor into a linear motion of the injection unit 300 may be used instead of the hydraulic cylinder 430.

### Control Device

The control device 700 is formed of, for example, a computer and includes a central processing unit (CPU) 701, a storage medium 702, such as a memory, an input interface 703, and an output interface 704 as shown in FIGS. 1 and 2. The control device 700 causes the CPU 701 to execute a program, which is stored in the storage medium 702, to perform various types of control. Further, the control device 700 receives a signal from the outside through the input interface 703, and transmits a signal to the outside through the output interface 704.

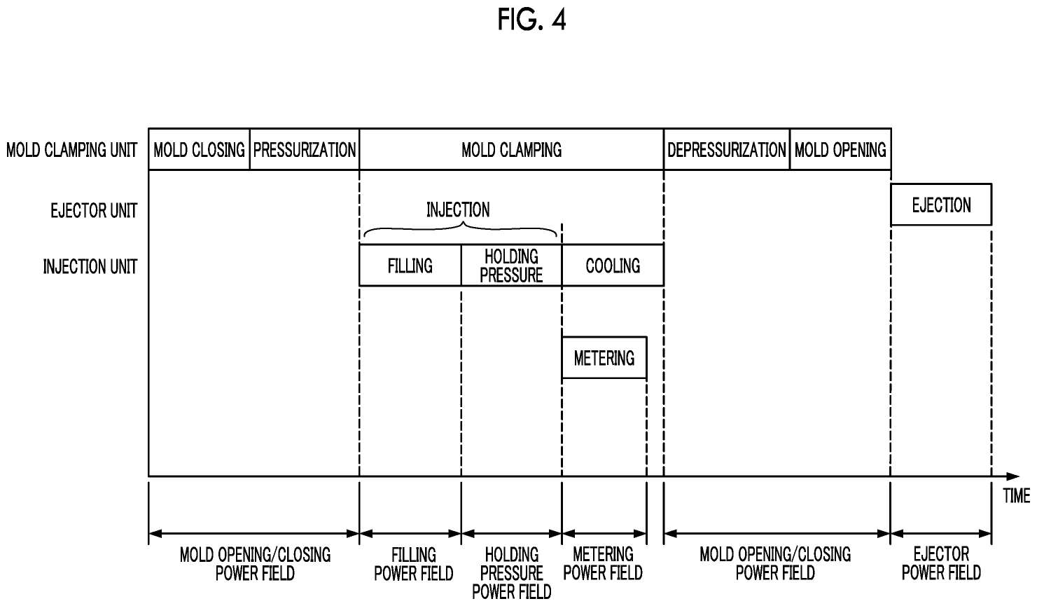

The control device 700 repeatedly performs the metering process, the mold closing process, the pressurization process, the mold clamping process, the filling process, the holding pressure process, the cooling process, the depressurization process, the mold opening process, the ejection process, and the like to repeatedly manufacture molding products (also see FIG. 4). A series of operations for obtaining molding products, for example, operations from the start of a metering process to the start of the next metering process are also referred to as a “shot” or a “molding cycle”. Further, a time required for one shot is also referred to as a “molding cycle time” or a “cycle time”.

One molding cycle includes, for example, the metering process, the mold closing process, the pressurization process, the mold clamping process, the filling process, the holding pressure process, the cooling process, the depressurization process, the mold opening process, and the ejection process in this order. The order mentioned here is an order in which the respective processes are started. The filling process, the holding pressure process, and the cooling process are performed during the mold clamping process. The start of the mold clamping process may coincide with the start of the filling process. The completion of the depressurization process may coincide with the start of the mold opening process.

A plurality of processes may be simultaneously performed for the purpose of shortening a molding cycle time. For example, a metering process may be performed during a cooling process of a previous molding cycle, or may be performed during a mold clamping process. In this case, the mold closing process may be performed at the beginning of the molding cycle. Further, the filling process may be started during the mold closing process. Furthermore, the ejection process may be started during the mold opening process. In a case where an on-off valve for opening and closing a flow channel of the nozzle 320 is provided, the mold opening process may be started during the metering process. The reason for this is that a molding material does not leak from the nozzle 320 as long as the on-off valve closes the flow channel of the nozzle 320 even though the mold opening process is started during the metering process.

One molding cycle may include processes other than the metering process, the mold closing process, the pressurization process, the mold clamping process, the filling process, the holding pressure process, the cooling process, the depressurization process, the mold opening process, and the ejection process.

For example, a pre-metering suck-back process for causing the screw 330 to retreat up to a preset metering start position may be performed before the start of the metering process after the completion of the holding pressure process. Since the pressure of the molding material accumulated in front of the screw 330 can be reduced before the start of the metering process, the sudden retreat of the screw 330 at the time of start of the metering process can be prevented.

Further, a post-metering suck-back process for causing the screw 330 to retreat up to a preset filling start position (also referred to as an “injection start position”) may be performed before the start of the filling process after the completion of the metering process. Since the pressure of the molding material accumulated in front of the screw 330 can be reduced before the start of the filling process, the leakage of the molding material from the nozzle 320 before the start of the filling process can be prevented.

The control device 700 is connected to an operation unit 750 that receives an input operation performed by a user and to a display unit 760 that displays a screen. The operation unit 750 and the display unit 760 may be formed of, for example, a touch panel 770 and may be integrated with each other. The touch panel 770 as the display unit 760 displays a screen under the control of the control device 700. For example, information, such as the settings of the injection molding machine 10 and the current state of the injection molding machine 10, is displayed on the screen of the touch panel 770. Further, for example, operation sections, such as buttons or input fields used to receive an input operation performed by a user, may be displayed on the screen of the touch panel 770. The touch panel 770 as the operation unit 750 detects an input operation performed on the screen by a user, and outputs a signal corresponding to the input operation to the control device 700. Accordingly, for example, a user can operate the operation section provided on the screen to set the injection molding machine 10 (including the input of a set value) while checking information displayed on the screen. Further, a user can operate the operation section provided on the screen to cause the operation of the injection molding machine 10, which corresponds to the operation section, to be performed. The operation of the injection molding machine 10 may be, for example, the operation (also including stopping) of the mold clamping unit 100, the ejector unit 200, the injection unit 300, the moving unit 400, or the like. Further, the operation of the injection molding machine 10 may be the switching of the screen that is displayed on the touch panel 770 as the display unit 760, or the like.

The operation unit 750 and the display unit 760 of the present embodiment have been described as being integrated as the touch panel 770, but may be provided independently of each other. Further, a plurality of operation units 750 may be provided. The operation unit 750 and the display unit 760 are disposed on an operation side (Y-axis negative direction) of the mold clamping unit 100 (more specifically, the stationary platen 110).

### Details of Control Device

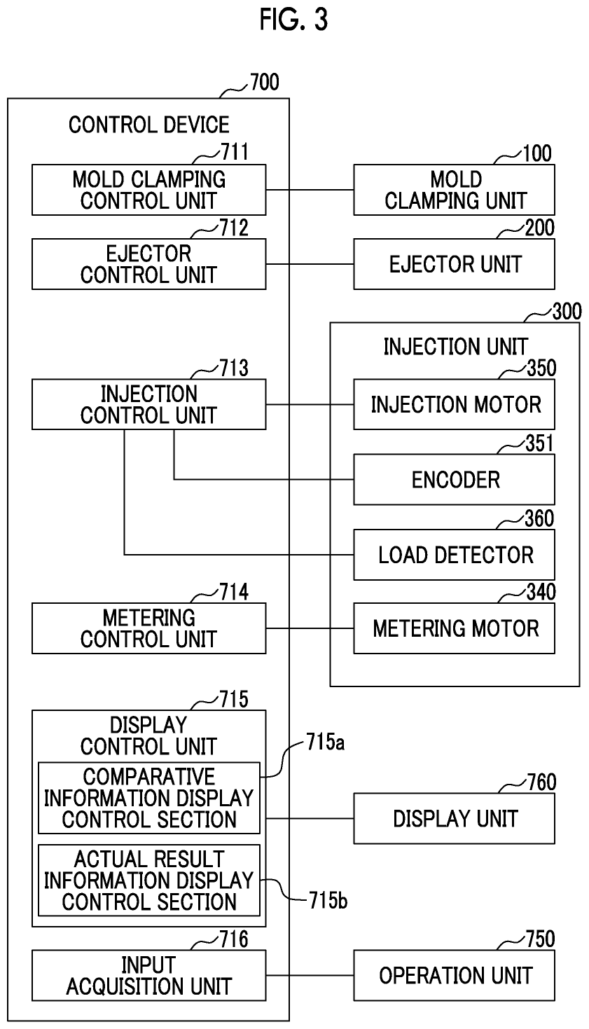

Next, an example of components of the control device 700 will be described with reference to FIG. 3. The respective functional blocks shown in FIG. 3 are conceptual and do not necessarily need to be physically configured as shown. All or a part of the respective functional blocks can be functionally or physically distributed and integrated as any unit. All or any part of each processing function performed by each functional block may be realized by a program executed by a CPU, or may be realized as hardware by a wired logic.

As shown in FIG. 3, the control device 700 includes, for example, a mold clamping control unit 711, an ejector control unit 712, an injection control unit 713, a metering control unit 714, a display control unit 715, and an input acquisition unit 716. The mold clamping control unit 711 controls the mold clamping unit 100, and performs the mold closing process, the pressurization process, the mold clamping process, the depressurization process, and the mold opening process shown in FIG. 4. The ejector control unit 712 controls the ejector unit 200 and performs the ejection process. The injection control unit 713 controls an injection drive source of the injection unit 300 and performs the injection process. The injection drive source is, for example, the injection motor 350 but may be a hydraulic cylinder or the like. The injection process includes the filling process and the holding pressure process. The injection process is performed during the mold clamping process. The metering control unit 714 controls a metering drive source of the injection unit 300 and performs the metering process. The metering drive source is, for example, the metering motor 340 but may be a hydraulic pump or the like. The metering process is performed during the cooling process.

The filling process is a process for controlling the injection drive source such that an actual result value of a movement speed of an injection member provided in the cylinder 310 reaches a set value. The filling process is a process for filling the inside of the mold unit 800 with liquid molding material (for example, a resin), which is accumulated in front of the injection member, by moving the injection member forward. The injection member is, for example, the screw 330 but may be a plunger.

The movement speed of the injection member is measured using a speed detector. The speed detector is, for example, the injection motor encoder 351. In a case where the injection member advances in the filling process, pressure acting on the molding material from the injection member is increased. The filling process may include a process for temporarily stopping the injection member or a process for causing the injection member to retreat, immediately before the holding pressure process.

The holding pressure process is a process for controlling the injection drive source such that an actual result value of pressure acting on the molding material from the injection member reaches a set value. The holding pressure process is a process for replenishing an insufficient amount of molding material due to cooling shrinkage in the mold unit 800 by pushing the injection member forward. The pressure is measured using a pressure detector, such as the load detector 360. A nozzle pressure sensor or a mold internal pressure sensor may be used as the pressure detector.

Further, the display control unit 715 of the control device 700 transmits information on a display screen related to the injection molding to cause the display unit 760 to display the information before the start of the injection molding, during each process in the injection molding and after the end of the injection molding, and the like. A plurality of display screens can be prepared, and the display control unit 715 allows the screens to be switched and displayed and allows the screens to be superimposed and displayed.

In addition, the input acquisition unit 716 of the control device 700 acquires information on operation contents in which a user operates the operation unit 750, on the basis of the display screen displayed on the display unit 760. For example, in a case where setting contents of the injection molding are changed by a user, the input acquisition unit 716 stores the setting contents in the storage medium 702.

### One Embodiment

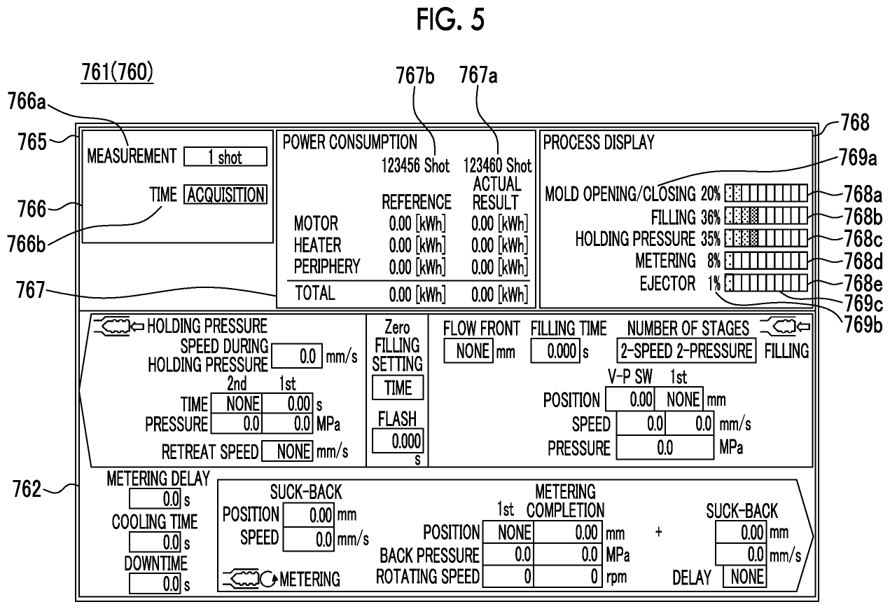

Next, an example of a display screen 761 displayed on a display unit 760 according to one embodiment will be described with reference to FIG. 5.

The display screen 761 displays a setting screen portion 762 that displays the setting contents of the injection molding of the injection molding machine 10, and a power screen portion 765 that displays power consumption of the injection molding based on the setting contents, together. “Display together” in this specification refers to a display form in which two screen portions (the setting screen portion 762 and the power screen portion 765) can be visually recognized on the same screen even though a user does not perform a manual operation for switching the screen portions. Accordingly, in addition to a form in which the setting screen portion 762 and the power screen portion 765 are displayed side by side in a vertical direction as shown in FIG. 5, the setting screen portion 762 and the power screen portion 765 may be displayed to be away from each other (such that another screen portion is interposed between the two screen portions). The power screen portion 765 is disposed above the setting screen portion 762 on the display screen 761 shown in FIG. 5 to make it easy for a user to recognize power consumption. However, on the display screen 761, the power screen portion 765 may be disposed below the setting screen portion 762, or the power screen portion 765 and the setting screen portion 762 may be disposed side by side in a horizontal direction.

The setting screen portion 762 is adapted such that the setting contents of the injection molding can be adjusted on the basis of user's operations, such as an input of a numerical value and the selection of options. The setting screen portion 762 displays, for example, setting contents in the holding pressure process, the filling process, and the metering process of the injection unit 300. A region of the holding pressure process displayed in the setting screen portion 762 shows the operation contents (a speed during holding pressure, a retreat speed, and the like) of the screw 330 in the holding pressure process of the injection molding, and is adapted such that the operation contents can be set. For example, in a case where a speed during holding pressure or a process speed is changed by a user, the operation of the screw 330 in the holding pressure process is changed and power consumption is also changed. A region of the filling process displayed in the setting screen portion 762 shows the operation contents (the V/P switching position, the movement speed, pressure, and the like) of the screw 330 in the filling process of the injection molding, and is adapted such that the operation contents can be set. For example, in a case where the V/P switching position, the movement speed, or pressure is changed by a user, the operation of the screw 330 in the filling process is changed and power consumption is also changed. A region of the metering process displayed in the setting screen portion 762 shows the operation contents (the switching of the pre-metering suck-back process and the post-metering suck-back process, the rotating speed, and the like) of the screw 330 in the metering process of the injection molding, and is adapted such that the operation contents can be set. For example, in a case where the switching of the pre-metering suck-back process and the post-metering suck-back process or the rotating speed is changed by a user, the operation of the screw 330 in the metering process is changed and power consumption is also changed.

In FIG. 5, the setting screen portion 762 does not display the setting of a mold clamping force of the mold clamping unit 100 in the mold clamping process and the setting of the ejector unit 200 in the ejection process. The reason for this is that the setting of a mold clamping force of the mold clamping unit 100 and the setting of the ejector unit 200 require adjustment work after the setting change for security. Of course, the display unit 760 is not limited thereto, and may be adapted such that the setting of the mold clamping process or the setting of the ejection process is displayed on the display screen 761 and can be changed.

Meanwhile, the power screen portion 765 includes a measurement operation screen portion 766 in which the measurement of power consumption is operated, an injection molding-total power-screen portion 767 that displays power consumption (the cumulative amount of power) for a predetermined measurement period, and a process-screen portion 768 that displays the power consumption of each process of the injection molding. The measurement operation screen portion 766, the injection molding-total power-screen portion 767, and the process-screen portion 768 are arranged in the power screen portion 765 shown in FIG. 5 in order from the left side to the right side, but this arrangement may be freely set.

The measurement operation screen portion 766 includes a measurement operation-input field 766a in which a measurement mode for power consumption can be set, and a comparative information-acquisition field 766b in which comparative information to be compared with power consumption is acquired. As will be described in detail later, the comparative information also serves as reference information in a case where power consumption is compared with the power consumption of current injection molding. Accordingly, in the following description, the comparative information may be referred to as a reference value or reference information and will be written as an item of “reference” in FIGS. 5 to 7.

The measurement operation-input field 766a includes a selection button that is used to display pull-down options in a case where, for example, a user performs a touch operation or performs the pressing (the click of a mouse, or the like) of a pointer displayed on the display screen 761. Since a plurality of numbers of shots or a plurality of measurement periods in a case where power consumption is acquired are prepared as the pull-down options, a user can arbitrarily select the displayed options. Power consumption in a case where the number of shots is 1 is the cumulative amount of power for one cycle in each process (each of the metering process, the mold closing process, the pressurization process, the mold clamping process, the filling process, the holding pressure process, the cooling process, the depressurization process, the mold opening process, and the ejection process).

The comparative information-acquisition field 766b includes an acquisition button that is used to acquire power consumption to be used for the number of shots or for a measurement period set in the measurement operation-input field 766a by a user's pressing operation. That is, a user can arbitrarily press the acquisition button of the comparative information-acquisition field 766b to obtain comparative information on the power consumption of the injection molding. “Pressing operation” performed by a user in this specification is merely an example of an operation, and it goes without saying that the input, acquisition, switching, and the like of information can be performed by, for example, other operations, such as a slide operation, performed on a touch panel.

The injection molding-total power-screen portion 767 displays two types of power consumption to allow a user to recognize the power consumption of the injection molding. Specifically, the injection molding-total power-screen portion 767 includes an actual result information display field 767a that displays power consumption measured at the time of performing the injection molding during an operation as actual result information, and a comparative information display field 767b that displays power consumption of the injection molding to be compared with the actual result information on the power consumption as the comparative information. For example, the actual result information display field 767a and the comparative information display field 767b are arranged side by side in the horizontal direction, and include a plurality of display items that are arranged in the vertical direction.

Each of the actual result information display field 767a and the comparative information display field 767b includes “shot number”, “power consumption of motor”, “power consumption of heater”, “power consumption of peripheral unit”, and “total power consumption” as the plurality of display items. The display item of “shot number” is a number indicating the number of shots in the injection molding. The actual result information display field 767a and the comparative information display field 767b may include, instead of “shot number”, information such as “date and time” when the comparative information and the actual result information were acquired. In FIG. 5, “power consumption of motor” is shown as “motor”, “power consumption of heater” is shown as “heater”, “power consumption of peripheral unit” is shown as “periphery”, and “total power consumption” is shown as “total”.

The display item of “power consumption of motor” displays cumulative power consumption used by a motor (the mold clamping motor 160, the metering motor 340, the injection motor 350, the ejector motor, and the like) in the injection molding. The display item of “power consumption of heater” displays cumulative power consumption used by a heater (the first heating unit 313, the second heating unit 323, and the like) in the injection molding. The display item of “power consumption of peripheral unit” displays cumulative power consumption used by a unit (various sensors, the control device 700, and the like) other than the motor and the heater in the injection molding. The display item of “total power consumption” displays total power consumption that is a total of the power consumption of the motor, the power consumption of the heater, and the power consumption of the peripheral unit.

In the injection molding-total power-screen portion 767, “shot number”, “power consumption of motor”, “power consumption of heater”, “power consumption of peripheral unit”, and “total power consumption” in the display of the actual result information display field 767a are arranged to have the same heights as those in the display of the comparative information display field 767b, respectively. For example, in a case where a measurement mode is one shot, the actual result information display field 767a displays cumulative power consumption whenever one cycle of the injection molding is completed. Accordingly, each display item is updated in the actual result information display field 767a in real time whenever one cycle of the injection molding is completed. The comparative information display field 767b acquires and displays the power consumption of one shot at a timing when the acquisition button is pressed, on the basis of, for example, a user's pressing operation of the acquisition button of the comparative information-acquisition field 766b. The comparative information display field 767b is information which is not changed (of which the display is fixed) even though one cycle is completed.

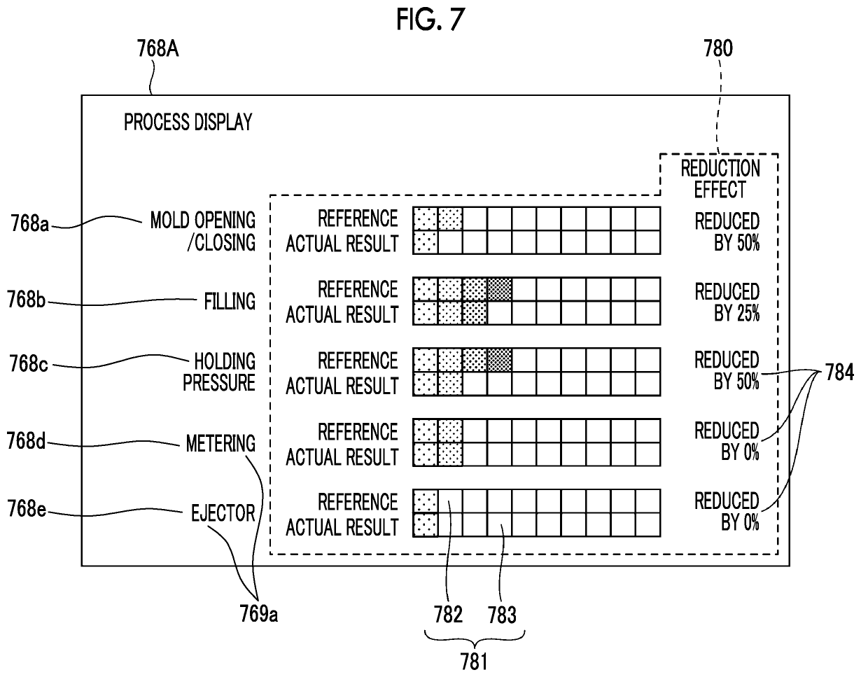

Further, the injection molding-total power-screen portion 767 displays the display of the actual result information display field 767a and the display of the comparative information display field 767b in the same display form. The “same display form” in this specification refers to a state in which a common expression, such as a numerical value or a graph, and/or a common unit (Wh, kWh, J, or the like) are used and which can be visually recognized by a user. For example, in a case where the power consumption in the actual result information display field 767a is displayed as a numerical value, the power consumption in the comparative information display field 767b is displayed as a numerical value. Here, it is more preferable that the power consumption is displayed in common units. Further, for example, in a case where the power consumption in the actual result information display field 767a is displayed as a graph (including a bar display and the like), the power consumption in the comparative information display field 767b is displayed as a graph (see also FIG. 7). Accordingly, a user can collectively visually recognize the actual result information on the real-time power consumption and the comparative information on the power consumption, which is arbitrarily set by the user, and can easily compare mutual differences.

In a case where there are a plurality of measurement modes of the measurement operation screen portion 766 or in a case where it is a measurement period, the injection molding-total power-screen portion 767 can change the display of the power consumption according to the contents of the measurement operation screen portion 766. For example, in a case where the measurement mode is set to two shots, power consumption corresponding to two shots is acquired as the comparative information on the basis of a pressing operation of the acquisition button of the comparative information-acquisition field 766b and is displayed in the comparative information display field 767b. Then, the actual result information display field 767a displays cumulative power consumption whenever two cycles (two shots) of the injection molding are completed. That is, since acquired power consumption is displayed in the actual result information display field 767a and the comparative information display field 767b on the basis of the set measurement mode, a user can easily compare the power consumption. Further, for example, in a case where the measurement mode is set to a measurement period of one hour, power consumption over one hour is acquired on the basis of a pressing operation of the acquisition button of the comparative information-acquisition field 766b and is displayed in the comparative information display field 767b. Then, cumulative power consumption is also displayed in the actual result information display field 767a each time the measurement period (one hour) has passed.

In a case where the acquisition button of the comparative information-acquisition field 766b is not pressed, the injection molding-total power-screen portion 767 may display only the actual result information display field 767a corresponding to the measurement mode of the measurement operation screen portion 766. In this case, the injection molding-total power-screen portion 767 may move the position of the actual result information display field 767a to the middle to change a display form from the display form in which the actual result information display field 767a and the comparative information-acquisition field 766b are arranged side by side.

Meanwhile, the process-screen portion 768 displays a ratio of the power consumption of each of the plurality of processes to the power consumption of the injection molding over one entire cycle (or the measurement period). Accordingly, the display unit 760 allows a user to recognize information on the power consumption for each of the plurality of processes.

However, even though the power consumption is displayed for each of the processes, since there are many processes of the injection molding as described above, information is difficult for a user to recognize. For this reason, in the present embodiment, the respective processes of the injection molding are grouped into five processes, and the power consumption thereof is used as information that is easily recognized by a user. Specifically, the process-screen portion 768 includes a mold opening/closing power field 768a, a filling power field 768b, a holding pressure power field 768c, a metering power field 768d, an ejector power field 768e, and a shot number field 768f.

Further, each of the plurality of display fields 768a to 768e includes an item display 769a, a ratio numerical value display 769b, and a ratio bar display 769c. That is, information on the power consumption of each process of the injection molding is displayed as a ratio of the power consumption of each process to the power consumption of the entire injection molding. Accordingly, the power consumption of each process is used as information that is more easily recognized by a user. Furthermore, even though the respective processes of actual injection molding are different from processes of the plurality of displayed display fields 768a to 768e, a user is allowed to recognize the information on the power consumption of each process as contents absorbing (or not including) a deviation since the information on the power consumption of each process of the injection molding is displayed as a ratio. The display of the process-screen portion 768 is not limited to a ratio and, for example, a numerical value (actual result value), reduced power consumption, or a reduction effect (a mark, or the like) may be applied.

In FIG. 5, the respective display fields 768a to 768e are arranged in a vertical direction, and the item displays 769a, the ratio numerical value displays 769b, and the ratio bar displays 769c are arranged in a horizontal direction. However, the arrangement of these may be reversed. In the ratio bar display 769c, for example, the power consumption of the entire injection molding is divided into squares in units of 10%, and the squares are displayed to be filled from the left side to the right side according to a ratio of the power consumption. The ratio bar display 769c may be displayed while the shade of a color is changed between a left square and a right square.

The mold opening/closing power field 768a displays a ratio of total power consumption of the respective processes (the mold closing process, the pressurization process, the depressurization process, and the mold opening process) related to the opening/closing movement (movement not including mold clamping) of the mold clamping unit 100 (see also FIG. 4). That is, there are many users who recognize the mold closing process and the pressurization process of the mold clamping unit 100 as a series of operations, and likewise, there are many users who also recognize the depressurization process and the mold opening process of the mold clamping unit 100 as a series of operations. For this reason, since total power consumption of the opening/closing movement of the mold clamping unit 100 is displayed, the total power consumption is used as information that is more easily understood by a user.

The filling power field 768b displays a ratio of the power consumption of the filling process in the mold clamping process (see also FIG. 4). The power consumption of the filling process includes power that is mainly used for an operation of the injection unit 300 and power that is mainly used for an operation (mold clamping process) of the mold clamping unit 100. In a case where a total of these powers on the same time axis is displayed in the filling power field 768b as the power consumption of the filling process, a user can easily recognize power that is used in the filling process.

Likewise, the holding pressure power field 768c displays a ratio of the power consumption of the holding pressure process in the mold clamping process (see also FIG. 4). The power consumption of the holding pressure process includes power that is mainly used for an operation of the injection unit 300 and power that is mainly used for an operation (mold clamping process) of the mold clamping unit 100. In a case where a total of these powers on the same time axis is displayed in the holding pressure power field 768c as the power consumption of the holding pressure process, a user can easily recognize power that is used in the holding pressure process.

The metering power field 768d displays a ratio of the power consumption of the metering process in the mold clamping process (see also FIG. 4). In this metering process, metering is performed by the metering motor 340 while the cooling process is performed in the injection unit 300, and the mold clamping process is continuously performed in the mold clamping unit 100. For this reason, in a case where a total of powers on the same time axis is displayed in the metering power field 768d as the power consumption of the metering process, a user can easily recognize power that is used in the metering process.

In a case where the cooling process is longer than the metering process, a time lag occurs between the metering process and the depressurization process (mold opening movement) in the injection molding machine 10, and the power of the mold clamping unit 100 and the power of the injection unit 300 continue to be used even during this time lag. However, since this time lag is small with respect to the entire injection molding time, the power consumption of the time lag is intentionally not displayed. Alternatively, for example, the injection molding machine 10 may calculate and display the power consumption of a time lag such that the power consumption of a time lag is included in the power consumption of the metering process.

The ejector power field 768e displays a ratio of the power consumption of the ejection process for taking out molding products after the mold clamping unit 100 is moved to be opened (see also FIG. 4). Accordingly, a user is allowed to recognize the power consumption of the operation of the ejector unit 200.

As shown in FIG. 3, for display of the power consumption in the above-mentioned power screen portion 765, the control device 700 includes a comparative information display control section 715a and an actual result information display control section 715b in the display control unit 715.

In a case where the comparative information display control section 715a recognizes that a user presses the acquisition button of the comparative information-acquisition field 766b, the comparative information display control section 715a acquires and displays the comparative information on the power consumption according to an injection mode set in the measurement operation screen portion 766 at that time. For example, the comparative information display control section 715a acquires the power consumption of one shot of the injection molding at a timing when the acquisition button is pressed as comparative information, and displays the comparative information in the comparative information display field 767b. In the acquisition of the power consumption, the comparative information display control section 715a individually calculates the power consumption of the motor, the power consumption of the heater, and the power consumption of the peripheral unit, and further calculates the total power consumption of the motor, the heater, and the peripheral unit.

On the other hand, the actual result information display control section 715b acquires and displays the actual result information on the power consumption according to the injection mode set in the measurement operation screen portion 766. For example, the actual result information display control section 715b repeatedly acquires the power consumption of each shot of the injection molding and updates the display of the actual result information display field 767a. In the acquisition of the power consumption, the actual result information display control section 715b individually calculates the power consumption of the motor, the power consumption of the heater, and the power consumption of the peripheral unit, and further calculates the total power consumption of the motor, the heater, and the peripheral unit. Further, the actual result information display control section 715b also individually calculates the power consumption of the respective display fields (the mold opening/closing power field 768a, the filling power field 768b, the holding pressure power field 768c, the metering power field 768d, and the ejector power field 768e: see FIG. 5) of the process-screen portion 768.

As described above, the control device 700 (display unit 760) of the injection molding machine 10 displays the actual result information on the power consumption and the comparative information on the power consumption in the same injection molding-total power-screen portion 767 together. For this reason, the display unit 760 allows a user to easily compare the comparative information on the power consumption of the injection molding, which is arbitrarily set by the user (acquired on the basis of a pressing operation of the acquisition button), with the actual result information on the power consumption that is measured in the injection molding. Accordingly, a user can directly compare the actual result information on the injection molding with comparative information that has been acquired in the past, and more easily recognizes a change in power consumption depending on the setting contents of the injection molding. Moreover, since the comparative information and the actual result information are displayed together, it is possible to complete examination of a policy for reducing the power consumption and the like on one screen and to more efficiently set molding conditions.

Further, the comparative information is acquired on the basis of a user's predetermined operation (pressing operation) that is performed in the comparative information-acquisition field 766b of the display screen 761. For this reason, the display unit 760 can easily acquire and display power consumption that is to be compared by a user. Furthermore, since the display unit 760 classifies and displays the power consumption of the injection molding according to a plurality of types (the motor, the heater, and the peripheral unit), it is possible to compare the power consumption for each of the plurality of types. Moreover, since the display screen 761 displays information on a shot number (or information on date and time) at the time of acquisition of the comparative information, it is possible to allow a user to reliably recognize a timing when the comparative information is acquired.

Since the power consumption is set in units of one cycle of the injection molding in the display of the power consumption, a user can easily identify the power consumption used in one cycle. Alternatively, in a case where the power consumption of the injection molding is set over a predetermined measurement period in the display of the power consumption, a user can easily identify the power consumption over the entire measurement period.

It goes without saying that the injection molding machine 10, the control device 700, and the display unit 760 are not limited to the above-mentioned embodiment, and various modification examples can be taken. For example, in the above-mentioned embodiment, the power consumption of the actual result information display field 767a and the power consumption of the comparative information display field 767b are displayed as numerical values. However, a bar graph of power consumption or a waveform graph that indicates a fluctuation in power consumption with respect to elapsed time may be used as a display form of the power consumption of the actual result information display field 767a and the power consumption of the comparative information display field 767b. In this case as well, a display form in which a user easily compares power consumption is provided. Further, the comparative information on the comparative information display field 767b is not limited to a display based on a user's operation, and may be automatically displayed under the control of the control device 700. For example, whenever the molding conditions of the injection molding are changed, the previous actual result information may be moved to the comparative information and may be displayed in the comparative information display field 767b. Alternatively, whenever the molding conditions of the injection molding are changed, power consumption may be automatically calculated and displayed in the comparative information display field 767b as comparative information. Further, a value before the change of the molding conditions of the injection molding, a value in a predetermined past period, an average value of predetermined past numbers of shots, and the like may be displayed in the comparative information display field 767b as comparative information.

Furthermore, in the display unit 760 according to the above-mentioned embodiment, the pressing of the acquisition button of the comparative information-acquisition field 766b serves as a trigger for the acquisition of the comparative information on the power consumption. However, as the comparative information on the power consumption, past information measured and stored in past injection molding may be used, or estimation information estimated from the setting contents of the injection molding may be used. A display unit 760 according to another embodiment that displays the past information or the estimation information on a display screen 761A will be described below.

### Another Embodiment

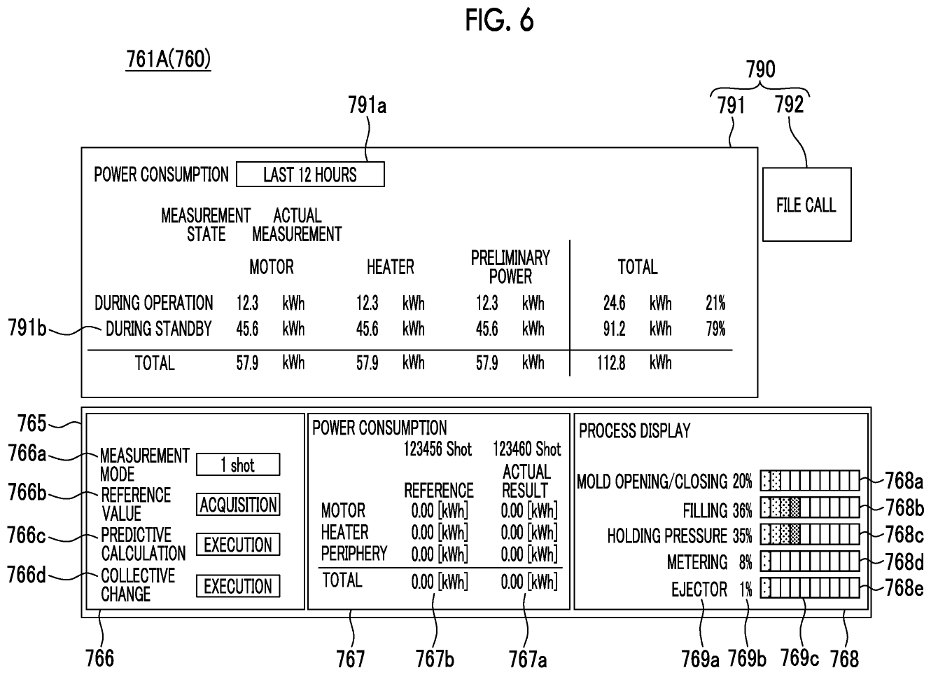

As shown in FIG. 6, the display screen 761A according to another embodiment displays a past data screen portion 790 that displays the past information in addition to the setting screen portion 762 and the power screen portion 765. For example, the past data screen portion 790 is disposed at a position adjacent to the power screen portion 765 (above the power screen portion 765 in FIG. 6).

The past information includes “power consumption of motor”, “power consumption of heater”, “power consumption of peripheral unit”, and “total power consumption” as the information on the power consumption, and includes the setting contents of the injection molding (contents displayed in the setting screen portion 762). Further, the past information may be the power consumption of a plurality of shots (“power consumption of motor”, “power consumption of heater”, “power consumption of peripheral unit”, and “total power consumption”) in a measurement period that is arbitrarily set by a user.

This measurement period is linked with the measurement mode of the measurement operation-input field 766a, and may be adapted to be capable of being appropriately selected from a plurality of periods, such as the last one hour, two hours, . . . 12-hour unit, one-day unit, one-week unit, and one-month unit, by a user. Each of “power consumption of motor”, “power consumption of heater”, “power consumption of peripheral unit”, and “total power consumption” can be called power consumption used in the selected measurement period. Further, the past information may include the amount of power during standby, which is preliminarily set, in addition to power consumption during an operation. The amount of power during standby can also be displayed for each of “amount of power of motor”, “amount of power of heater”, “amount of power of peripheral unit”, and “total amount of power”. Since the display unit 760 uses the power consumption during an operation and the amount of power during standby, the display unit 760 can show information on power that can be supplied to the injection molding machine 10 and a ratio of the power to a user.

Furthermore, the past data screen portion 790 includes a display region 791 that allows a user to actually visually recognize the past information, and a file call button 792 that calls up the past information. The display region 791 includes an execution period display field 791a that shows the above-mentioned measurement period, and a result display field 791b that shows information on “power consumption of motor”, “power consumption of heater”, “power consumption of peripheral unit”, and “total power consumption” in a predetermined execution period.

The file call button 792 is a button that is used to read out the past information on each shot in the measurement period displayed in the display region 791 on the basis of a user's pressing operation (or the past information corresponding to the setting contents of the measurement mode). The file call button 792 may display a list of one or more pieces of past information stored in the storage medium 702 on the basis of a user's pressing operation to allow a user to select the past information. It is preferable that a shot number, date and time when power consumption was measured, total power consumption, and the like are displayed in the list of the past information displayed in this case. Further, the display region 791 may display information, which is selected by a user's first selection operation (for example, single click) from the list of the past information called up using the file call button 792, in the result display field 791b of the display region 791.

Furthermore, the display unit 760 displays information, which is selected by a user's second selection operation (for example, double click) from the list of the past information, in the comparative information display field 767b of the power screen portion 765. Accordingly, the display unit 760 can smoothly reflect the past information, which is stored in the storage medium 702, in the comparative information. In this case, the setting contents of the injection molding associated with the past information are displayed in the setting screen portion 762 together with the past information. For this reason, since a user can easily compare the actual result information on the acquired power consumption with the power consumption corresponding to the setting contents created in the past while checking the setting contents, the user can easily recognize an effect of improvement from the past.

Further, the measurement operation screen portion 766 of the display screen 761A includes a predictive calculation field 766c and a collective change field 766d. For example, in a case where a user changes the setting contents of the injection molding in the setting screen portion 762 (see FIG. 5) and then presses a prediction button of the predictive calculation field 766c, the control device 700 (display control unit 715) calculates prediction information on the power consumption corresponding to the setting contents. That is, the prediction information is an example of estimation information in this specification. Then, the display control unit 715 displays the calculated prediction information on the power consumption in the comparative information display field 767b as the comparative information.

Specifically, the display control unit 715 includes a prediction unit (not shown) calculating prediction information using setting contents that are acquired via the input acquisition unit 716 and a function of power consumption (or a database in which the operations of the motor, the heater, and the peripheral unit are associated with power consumption) that is held in advance. The calculation of the prediction information in the prediction unit is an example of “estimation” in this specification. The prediction unit calculates prediction information on the power consumption of each of the motor, the heater, and the peripheral unit according to the display form of the comparative information display field 767b, and further calculates prediction information on total power consumption of the motor, the heater, and the peripheral unit. Accordingly, the display unit 760 can smoothly display the calculated prediction information in the comparative information display field 767b. For this reason, since a user can easily compare the power consumption, which is displayed in the actual result information display field 767a, with the power consumption that is predicted on the basis of the setting contents and that is displayed in the comparative information display field 767b, the user can recognize a difference between the prediction information and the actual result information caused by a change. The information which is to be compared with the prediction information is not limited to the actual result information, and the display unit 760 may be adapted to display the prediction information in the actual result information display field 767a according to a user's operation and to compare the comparative information, which is displayed in the comparative information display field 767b, with the prediction information.

The collective change field 766d is disposed below the predictive calculation field 766c. The collective change field 766d includes a collective change button that is used to collectively change the power consumption displayed in the comparative information display field 767b of the power screen portion 765 and the setting contents of the setting screen portion 762 associated with the power consumption. That is, the display control unit 715 can set setting contents, which are currently displayed in the setting screen portion 762, as new setting contents via a user's pressing operation of the collective change button.

For example, in a case where a user presses the collective change button after visually recognizing a difference between the prediction information based on the setting contents of changed temporary molding conditions and the actual result information on the power consumption, the temporary molding conditions can be reflected in the current molding conditions. On the contrary, the display control unit 715 is adapted such that the temporary molding conditions are not reflected as setting contents during an operation until the collective change button is pressed. Accordingly, even in a case where the injection molding machine 10 fully automatically produces molding products, it is possible to predict power consumption caused by a change in the setting contents and to examine a policy of changing setting contents without stopping production.

In a case where a user presses the collective change button of the collective change field 766d in a state where past information is displayed in the comparative information display field 767b, setting contents corresponding to the past information may also be collectively changed. Accordingly, the injection molding machine 10 can easily reuse the past information.

### Modification Example

Further, the display control unit 715 (see FIG. 3) may be adapted to change the display form of the process-screen portion 768 on the basis of a trigger in which the acquisition button of the comparative information-acquisition field 766b is pressed (the prediction button is pressed, past information is selected, or the like). For example, as shown in FIG. 7, a process-screen portion 768A according to a modification example switches portions (the ratio numerical value displays 769b and the ratio bar displays 769c) of the plurality of display fields 768a to 768e, which are adjacent to the item displays 769a in a horizontal direction, to a process-comparison display portion 780.

The process-comparison display portion 780 displays ratio bar displays 781 and numerical value displays 784 for a reduction effect together side by side in the horizontal direction. In the ratio bar display 781, for example, the power consumption of the entire injection molding is divided into squares in units of 10%, and the squares are displayed to be filled from the left side to the right side according to a ratio of the power consumption. The ratio bar display 781 may be displayed while the shade of a color is changed between a left square and a right square.

Further, the ratio bar display 781 of each of the plurality of display fields 768a to 768e is divided into two stages in the vertical direction, includes a comparative bar display 782 on an upper side thereof, and includes an actual result bar display 783 on a lower side thereof. Each comparative bar display 782 is a process-comparative information display field that displays a ratio of the power consumption of the comparative information (reference information) (a ratio of the power consumption of each process to the power of the entire injection molding) (see also FIG. 5). On the other hand, each actual result bar display 783 is a process-actual result information display field that displays a ratio of the power consumption of the actual result information (a ratio of the power consumption of each process of the actual result information to the power consumption of each process of the comparative information). The ratio bar display 781 may show a ratio of the power consumption of each process to the power of the entire injection molding in the actual result bar display 783, and may show a ratio of the power consumption of each process of the comparative information to the power consumption of each process of the actual result information in the comparative bar display 782.

Since a ratio of the power consumption of each process of the actual result information to the power consumption of each process of the comparative information is rounded off to increase or decrease in resolution in a plurality of stages (0%, 25%, 50%, 75%, 100%, and the like), the ratio does not need to be calculated as a detailed ratio. For example, in a case where a detailed ratio is less than 12.5%, the detailed ratio is rounded off to 0%. In a case where a detailed ratio is 12.5% or more and less than 37.5%, the detailed ratio is rounded off to 25%. Accordingly, the ratio is used as information that is easily recognized by a user.

A part of an example shown in FIG. 7 will be described here. In a case where a ratio of the power consumption of the mold opening or closing process of the comparative information (reference information) is 20% of the power consumption of the entire injection molding, two squares are filled in the comparative bar display 782. Meanwhile, in a case where the power consumption of the mold opening or closing process of the actual result information is about 50% of the power consumption of the mold opening or closing process of the comparative information, the display control unit 715 fills one square in the actual result bar display 783 (reduces the number of filled squares by one). Further, the display control unit 715 causes the numerical value display 784 for a reduction effect to display that the ratio is reduced by 50%.

Furthermore, for example, in a case where a ratio of the power consumption of the filling process of the comparative information is 36% of the power consumption of the entire injection molding, four squares are filled in the comparative bar display 782. Meanwhile, in a case where the power consumption of the filling process of the actual result information is about 75% of the power consumption of the filling process of the comparative information, the display control unit 715 fills three squares in the actual result bar display 783 (reduces the number of filled squares by one). In addition, the display control unit 715 causes the numerical value display 784 for a reduction effect to display that the ratio is reduced by 25%.

As described above, the display unit 760 allows a user to compare the actual result information and the comparative information on each of the plurality of processes of the injection molding using the process-screen portion 768. Further, since the process-screen portion 768 displays the comparative bar displays 782 and the actual result bar displays 783 together, a user is allowed to easily visually recognize a change in the power consumption of each process. Moreover, since a reduction effect for power consumption is indicated as a numerical value by the numerical value display 784 for a reduction effect positioned adjacent to the ratio bar display 781, the reduction effect can be used as information that is further easily understood by a user. In a case where the prediction information is applied as the comparative information and, for example, a ratio of the power consumption of the comparative bar display 782 to the power consumption of the actual result bar display 783 is shown, a user is allowed to smoothly recognize a reduction effect for the power consumption corresponding to the setting contents.

The display unit 760, the control device 700, and the injection molding machine 10 according to the embodiments disclosed herein are exemplary in all respects, and are not limited. The embodiments can be modified and improved in various forms without departing from appended claims and the scope of the claims. The items described in the plurality of embodiments may include other components within a consistent range, and may be combined within a consistent range.

It should be understood that the invention is not limited to the above-described embodiment, but may be modified into various forms on the basis of the spirit of the invention. Additionally, the modifications are included in the scope of the invention.

What is claimed is:

1. A display unit that displays a display screen including information on injection molding,
wherein the display screen displays an actual result information display field that displays actual result information on power consumption measured at a time of performing the injection molding and a comparative information display field that displays comparative information on power consumption of the injection molding to be compared with the actual result information on the power consumption in the same display form as a display form of the actual result information display field together.

2. The display unit according to claim 1,
wherein the actual result information and the comparative information are power consumption in units of one cycle of the injection molding or power consumption of the injection molding over a predetermined measurement period.

3. The display unit according to claim 1,
wherein the display screen displays information on a shot number or information on date and time at a time of acquisition of the comparative information together with the comparative information display field.

4. The display unit according to claim 1,
wherein the display form of the actual result information display field and the display form of the comparative information display field are at least one of a numerical value, a bar graph, and a waveform graph that indicates a fluctuation in the power consumption with respect to elapsed time.

5. The display unit according to claim 1,
wherein the injection molding is divided into a plurality of processes, and
the display screen includes a process-screen portion that individually displays information on the power consumption for each of the plurality of processes.

6. The display unit according to claim 5,
wherein the process-screen portion includes a process-actual result information display field that displays a ratio of actual result information on the power consumption of each of the plurality of processes to power consumption of the entire injection molding as the information on the power consumption of each of the plurality of processes, and a process-comparative information display field that displays a ratio of comparative information on the power consumption of each of the plurality of processes to the power consumption of the entire injection molding which is arbitrarily set by a user.

7. The display unit according to claim 1,
wherein the comparative information is power consumption of the injection molding acquired on the basis of a user's predetermined operation that is performed in a comparative information-acquisition field of the display screen.

8. The display unit according to claim 1,
wherein the comparative information includes past information that is measured and stored in past injection molding or estimation information that is estimated from setting contents of the injection molding.

9. The display unit according to claim 8,
wherein the display screen includes a setting screen portion which displays the setting contents of the injection molding and in which the setting contents of the injection molding are changeable on the basis of a user's operation, and
the estimation information is the power consumption that is calculated on the basis of setting contents of the injection molding changed in the setting screen portion.

10. A control device that causes the display unit according to claim 1 to display the display screen.

11. An injection molding machine comprising:
the control device according to claim 10.
